(19) United States
(12) Patent Application Publication
(10) Pub. No.: US 2023/0158341 A1
(43) Pub. Date: May 25, 2023

(54) FACE MASK AND SYSTEM

(71) Applicants: Alan BRITTEN, London (GB); PH6 LTD, London (GB)

(72) Inventor: Alan BRITTEN, London (GB)

(21) Appl. No.: 17/920,411

(22) PCT Filed: Apr. 20, 2021
(86) PCT No.: PCT/IB2021/053235

§ 371 Date: Oct. 21, 2022

(30) Foreign Application Priority Data
Apr. 22, 2020 (GB) 2005856.6
Jul. 8, 2020 (GB) 2010507.8
Nov. 11, 2020 (GB) 2017809.1

(51) Int. Cl. A62B 18/02; A62B 18/10; A62B 18/00

(52) U.S. Cl. CPC A62B 18/02; A62B 18/10; A62B 18/006

(57) ABSTRACT

A face mask system for removal of pathogens from exhaled air comprising at least one flexible layer comprising a first surface and a second surface, said second surface being opposite to the first surface, and the first surface being in sealingly contact with the face of a user and the second surface being exposed to the environment, wherein at least one layer is provided with an exit port and an inlet port and further wherein the exit port is sealingly connected to a deformable outflow chamber and said exit port further comprising a one way exit valve that is configured to open when a user exhales air and which exit valve closes when the user inhales air.

The present invention relates to a face mask and system. Particularly the present invention relates to a face mask and system with a high capture rate of airborne pathogens. More particularly it relates to a face mask with a high capture rate of pathogens expelled from coughs/sneezes etc. Even more particularly the invention relates to a face mask with a high capture rate of pathogens expelled from coughs/sneezes etc. without restricting the users breathing.

### BACKGROUND OF THE INVENTION

The transmission of diseases from an infected person to others is frequently by the infected person releasing pathogens into their surroundings through their breath, coughs or sneezes. This route of infection is well known, and has played a major role in the annual cycle of diseases such as influenza, TB, epidemics and pandemics such as SARS and H1N1 [Tellier R, Review of Aerosol Transmission of Influenza A Virus Raymond Emerging Infectious Diseases, www.cdc.gov/eid Vol. 12, No. 11, November 2006]. Governments and bodies such as the WHO develop national and international plans and aim to advise on appropriate actions to attempt to avoid a disease spread becoming an epidemic, or a pandemic. The appropriate actions to limit spread will depend upon the specific pathogen, but a major route especially for infections involving the respiratory system, is through droplets or aerosols emitted by an infected person through normal breathing, talking, coughing and sneezing [Cough aerosol in healthy participants: fundamental knowledge to optimize droplet-spread infectious respiratory disease management Zayas et al. BMC Pulmonary Medicine 2012, 12:11]. Healthcare workers, and others coming within close contact with the infected individual, may be advised to wear a face mask of an appropriate type, and perhaps also eye protection, other protective clothing and to ensure strict hand washing. Within the material expelled from the patient there is gas, droplets and smaller particles known as aerosols, typically defined as being under 5μm diameter. Such aerosols may have a greater chance of infecting others since they behave more like a gas, staying in the air for a long time and potentially travelling further. Aerosols also penetrate further into the lungs of a person and more reach the alveoli of the lungs where a lower dose of pathogen is needed to infect the subject [Roy C J, Milton D K. Airborne transmission of communicable infection—the elusive pathway. N Engl J Med 2004;350:1710-2].

Aerosols are harder to remove from the emissions from the patient since they are small and have a higher chance of penetrating a mask, and because they behave similar to a gas they can pass around a mask through any leaks caused by gaps between the mask and the patient's face. The problems of poor mask fit, for masks worn by patients and carers, are well documented [https://www.hse.gov.uk/research/rrpdf/rr619.pdf, Evaluating the protection afforded by surgical masks against influenza bioaerosols Gross protection of surgical masks compared to filtering facepiece respirators, Prepared by the Health and Safety Laboratory for the Health and Safety Executive 2008, RR619]. If masks are recommended for patients then they are usually of the “surgical mask” type, which reduce pathogens significantly but which still allow release of virus or bacteria into the environment. This is particularly true when patient coughs or sneezes, since the rapid, often described as “explosive”, nature of these raises the pressure behind the mask rapidly and air and expelled droplets and aerosols flow around the mask through gaps between the mask and skin [ “Violent Expiratory Events: On Coughing and Sneezing.” Bourouiba et al, Journal of Fluid Mechanics 745 (Mar. 24, 2014): 537-563.].

The viral or bacterial load in an environment is a major risk for healthcare workers, and others who may be in contact with the person, for example ambulance workers picking up a patient to transport them to hospital, nurses, doctors and other healthcare workers in hospitals, carers including family in the community or infected person's home, or carers in residential care homes.

Masks with higher filtration efficiency, and better facial fit, such as the N95 masks [See the HSE reference above for details and references to mask types] and the FFP2 and FFP3 masks, may be used, but only the FFP3 masks have a high efficiency for removing aerosols [Efficacy of face masks in preventing inhalation of airborne contaminants, David J. Pippin, DDS, MS, Richard A. Verderame, DDS, Kurt K. Weber, DDS‡ Journal of Oral and Maxillofacial Surgery, April 1987Volume 45, Issue 4, Pages 319-323]. However, the use of FFP3 or similar masks is problematic for patients with a cough or sneeze, since the speed of the expelled air volume cannot pass sufficiently quickly through the mask and so a high pressure is built up behind the mask that then pushes air and aerosols and possibly even larger particles through gaps between the mask and the wearer's face. Also the filter on the high performance masks is in the front of the mask and is likely to get saturated quickly if worn by a patient with cough or sneeze due to the higher amount of wet droplets emitted with every cough or sneeze, and the masks are not designed to function in these conditions of dealing with hyper-secretions from an ill patient.

It is therefore clear that though high performance filtering masks may be used, they are not designed for patient use when the patient has respiratory symptoms, especially if coughing or sneezing, or if the subject needs any form of gas delivered such as oxygen therapy.

There has been no solution to the need to have a high capture efficiency for respiratory pathogens expelled from breathing and cough or sneeze, whilst allowing good medical access to the patient. Patients who are not themselves in need of airways support through non-invasive ventilation are nevertheless capable of spreading virus and bacteria, but they also have needs in terms of eating and drinking and personal care which can be carried out with the removal of a mask to eat or drink, using good tissue cough and sneeze hygiene for the short periods when a mask cannot be worn. Though such removal of a mask increases the release of pathogens, particularly if good cough and sneeze hygiene is not performed, overall the viral or bacterial load in the room are will still be significantly reduced if there is a highly efficient pathogen removal device in use for most of the time, and it is this type of device that has previously been unavailable.

Review of the prior art shows that catching cough and sneeze expelled droplets has been the subject of a number of patents, including the use of handheld items to attempt to “catch the cough” or sneeze, such as (U.S. Pat. No. 7,997,275 B2, Quin, 2011, US 2014/0251349 A1, Delatorre 2014).

There have also been devices that aim to apply bacterial or viricidal agents to the cough or sneeze material as it passes through a mask (U.S. Pat. No. 4,790,307, Haber et al 1988), but none have addressed the well recognised problem that masks do not perform well in physically containing an explosive sneeze or cough, and even devices that claim to do this in a single mask do not offer any evidence that they can deal with the known factors of large volumes needing to be contained from explosive coughs or sneezes (US US 2015/0013681 A1, APPARATUS WITH EXHAUST SPACER TO IMPROVE FILTRATION OF PATHOGENS IN RESPRATORY EMISSIONS OF SNEEZES, and WO 2018/080577 A1 2017, Bird J.).

In a healthcare context there have been attempts to address some of the issues described, and US patent US005676133A (Hickle et Al, 1997) EXPIRATORY SCAVENGING METHOD AND APPARATUS AND OXYGEN CONTROL SYSTEM FOR POST ANESTHESA CARE PATIENTS reveals an invention that is primarily aimed at scavenging anaesthetic gas but which also has the benefits of removing pathogens from the expired material. This system uses an anaesthetic face mask, and is not able to manage the high volume and pressure of coughing and sneezing, and it is not applicable in hospital ward or primary care settings.

Other highly specialised approaches include managing laminar flow of air in a room to remove pathogens by large scale air flow (U.S. Pat. No. 9,310,088 B2, Melikov et al 2016), but this level of technology is not available for large scale use such as in epidemics or pandemics, nor in a domestic or primary care setting or in ambulance transport.

A USA patent 2004/0084.048 to Stenzler et al, 2002 reveals an invention that is aimed at allowing high oxygen concentration delivery to a patient, and also with an expiratory route in the mask that the patent states can be used with a filter inserted in the route to remove pathogens and other material. The principle of filters in exhalation routes from ventilators and masks is well known and exists in many commercially available products, for example Flow Guard filters (Intersurgical Ltd UK) in-line filters to filter exhaled air from patients on ventilators, and filters can also be installed in expiration ports in the body of the mask and are commercially available such as the Filta Mask from Intersurgical Ltd UK, with another example in Canadian Patent CA2567266 C Aug. 7, 2012 “DISPOSABLE MASK ASSEMBLY WITH EXHAUST FILTER AND METHOD OF ASSEMBLING SAME”. The patent 2004/0084.048 to Stenzler et al, 2002 states that “A mask assembly is described that comprises an inspiratory and expiratory limb each containing a very low resistance one way valve, and”. The patent gives a figure relating flow rates and pressures, reproduced in FIG. A1.

Two points are noted: 1) the resistance pressure and flow is only quoted for the inspiratory limbs, and so the assumption seems to be have been made by the authors that this curve also applies to the expiratory limb 2) The flow rate is presented as L/min, and without any further clarification by the authors this is reasonably taken as a continuous flow rate. For filtration material such flow-resistance curves at steady state flow rates are common, and the rates and resistances overlap with those for other commercial filter materials (eg Intersurgical UK Flow Guard material). It is acknowledged that this common approach will deal with exhaled fluid from breathing, but we can demonstrate that it is not able to deal with the extremely important condition of cough and sneeze from infected people. The demonstration of this rests on the fact that that the resistance-flow relationship under cough and sneeze conditions is completely different from the resistance-flow relationship that has been presented in figure. Cough and sneeze are events that produce boluses of aerosol with very high rate of flow acceleration, a rise from zero to 10 L/s in 50 to 100 ms, even though the rate of flow achieved is not exceptionally high (there is a wide range in humans, say 2-12 L/s for adults). When a fluid bolus meets any form of resistance there is an inevitable and rapid pressure rise since the bolus momentum has to be lost in decelerating in attempting to pass through the filter material. We have made measurements that have demonstrated the high pressure resistance to cough or sneeze flow rates with use of filters that are rated as low resistance at steady flow rates. The measurements were performed with a high quality low resistance in-line filter (Intersurgical UK Flow Guard Filter), designed to filter air lines in medical applications, and is rated for steady state flow at 0.4 mmH2O resistance at 30 L/min. The measurements also included the commercially available Filta Mask (Intersurgical UK) which has two inbuilt filters in the mask body). The following graph FIG. A1 shows the pressure under the three masks (PS is the mask employing the ultra-low resistance presented in this application, ISFM is the Intersurgical Filta Mask and H1 is the mask using the Intersurgical Flow Guard in-line filter for the expiratory outflow) in response to a human cough flow profile of approximately 8 L/s peak flow and time to peak flow of 0.1 to 0.2s.

As is seen in figure A2 the high resistance to cough and sneeze flow rates for the two examples of masks (ISFM as the face mask with filter material set into the mask, and H1 which follows the principles set out in the Stenzler application) means that the expiratory path becomes a very high resistance route, in the range 100-125 mmH2O when using either “low resistance” filter material set into the mask or as an in-line filter, and therefore the proposed solution in US patent 2004/0084.048 to Stenzler et al, 2002 does not provide “very low flow resistance” under normal physiological cough and sneeze, and so does not work to capture pathogens from the range of physiological conditions including cough and sneeze commonly seen in humans with respiratory diseases.

We have also made the observation from our experiments that a pressure increase of even only 50 mmH2O under a mask when a patient coughs or sneezes is sufficient to move the mask off of the face location, causing not only loss of aerosol to the room but also discomfort and possibly leading to non-compliance in proper wearing in order to leave an air gap to release the pressure under cough or sneeze. Therefore the ability to deal with these pressures caused by common and major components of respiratory disease is fundamental to the function of the device to capture cough and sneeze, and without a means of capturing these even the capture of normally breathed exhaled fluid is likely to be compromised.

The object of the invention is to reduce release of pathogens from an infected person's respiratory system into the air, for example into room air or air in an ambulance, achieved by a mask and system to capture oral and nasally expired gas, aerosols and particles and thereby ensuring that a very high fraction of the expelled material is not released into the environment, even when the patient is coughing or sneezing. The term “expelled material” is used to describe the gas, droplets and aerosol that the subject expels from their mouth or nose, for example during breathing, talking, coughing or sneezing. The pathogens are then removed from or killed in the captured material before the expelled material is released into the environment. The invention also allows access for medical staff to deliver oxygen or other therapy without compromising the removal of pathogens.

The device does this by providing a low resistance pathway for the expelled materials, so that even for an explosive cough or sneeze the pressure within the mask does not rise sufficiently to cause back flow around the mask edge. The expired breath, cough or sneeze passes through an outflow valve that opens at low pressure, and which then closes to reduce the potential of re-breathing of the expelled materials. The expelled then passes into a deformable chamber and is filtered before being exhausted to the environment, or directed along an airway, optionally with applied suction, and then filtered or directed to a processing unit where pathogens are removed or killed before the air flow is vented back to the room or the exhaust released to the outside environment.

According to a first aspect of the invention there is provided a face mask system for removal of pathogens from exhaled air comprising at least one flexible layer comprising a first surface and a second surface, said second surface being opposite to the first surface, and the first surface being in sealingly contact with the face of a user and the second surface being exposed to the environment, wherein at least one layer is provided with an exit port and an inlet port and further wherein the exit port is sealingly connected to a deformable outflow chamber and said exit port further comprising a one way exit valve that is configured to open when a user exhales air and which exit valve closes when the user inhales air.

An embodiment of the first aspect, wherein the exit port is of a diameter that is dimensioned not to impede the flow of exhaled air into the deformable chamber by means of the one-way exit valve.

An embodiment of the first aspect, wherein the inlet port comprises an inlet valve that is configured to open when a user inhales air and which inlet valve closes when the user exhales air and further wherein the inlet valve is configured to open by the difference in pressure between the first surface of the at least one layer and atmospheric pressure of the environment.

The deformable outflow chamber may be sealingly connected to a processing unit by means of a flexible conduit, said conduit configured to transport expelled matter from the user via the exit port of the at least one layer and the deformable outflow chamber.

The processing unit may be connected to a suction means comprising an exhaust outlet and said suction means configured to provide suction through the conduit via the processing unit and the deformable outflow chamber to define from the exit port a path of exhaled air, said suction means optionally comprising an electrostatic deposition unit and a filter to provide a clean gas output at the exhaust outlet of the suction means, and further wherein the processing unit comprises a valve, and a sensor.

An embodiment of the first aspect, wherein the deformable outflow chamber is sealingly connected to a suction means by means of a conduit, said conduit configured to transport expelled matter from the user via the exit port of the at least one layer and the deformable outflow chamber. The flow rate in the path of exhaled air may be set or variably controlled by the suction means and optionally in a feedback arrangement with a sensor in the path of exhaled air.

The valve may configured to open to allow air into the system through the inlet pipe or it opens to let expelled material through an over-pressure line via a filter.

An embodiment of the first aspect, wherein the outflow is low resistance such that expelled air passes into the output chamber without a significant rise in pressure between the user and the first surface of the at least one layer.

According to a second aspect of the invention there is provided an outflow chamber suitable for use with the face mask system of the first aspect comprising: a lightweight deformable chamber having a one way inlet for sealed connection to an outlet of a face mask, and a one way outlet valve distal the inlet, the chamber increasing in volume as internal pressure rises and decreases as internal pressure drops. The outflow chamber may further comprise at least one support strip attached to a surface of the outflow chamber, the at least one support strip being deformable between a first preferred concave shape and a second convex shape relative to the outflow chamber, the strip being biased towards the first preferred concave shape. Such that as the internal pressure of the outflow chamber increases in relation to ambient pressure, the support strip transitions from the concave position to the convex position and urges the outflow chamber to a larger internal volume, as the internal pressure decreases the support strip returns to its preferred concave position. The outflow chamber may comprise a plurality of support strips.

An embodiment of the second aspect wherein each of the plurality of support strips transition from the first position to the second position at different internal pressures of the outflow chamber.

### BRIEF DESCRIPTION OF THE DRAWINGS

The invention will be described in more detail, by way of example, with reference to the following drawings:

FIG. 1 Is a side view of the system, with a mask covering both nose and mouth

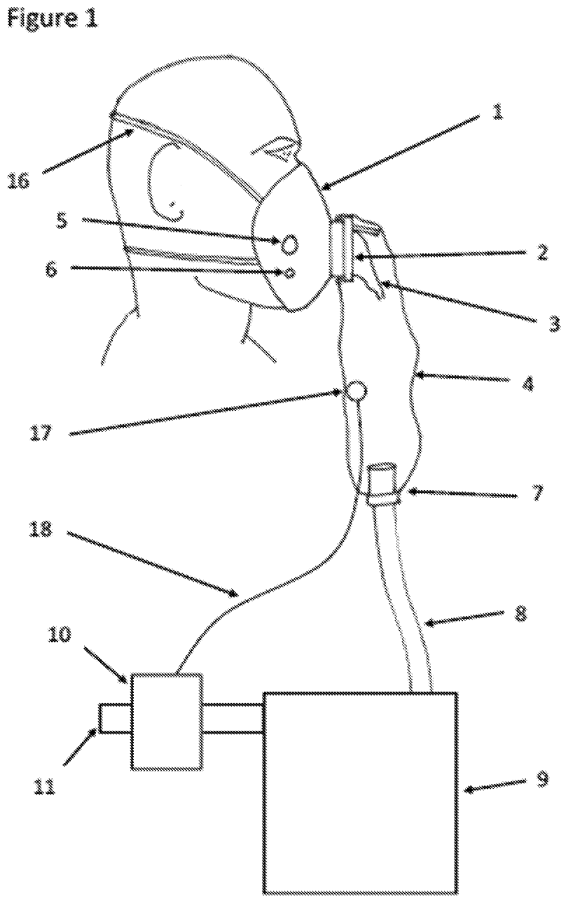

FIG. 2 Is side view of the system, with a mask covering just the mouth

FIG. 3 Is a front view of part of the system, showing the mask and upper air handling system

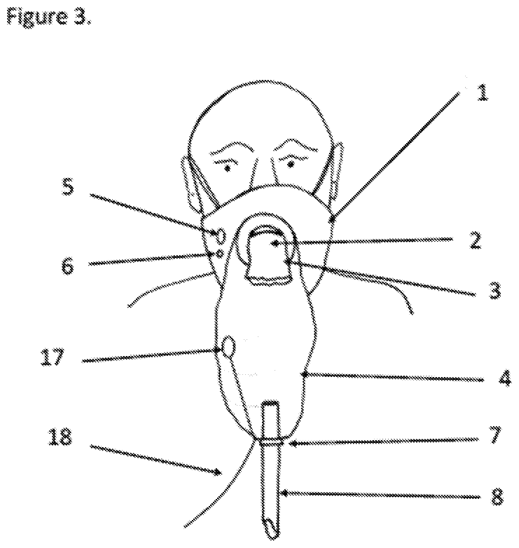

FIG. 4 Is a side view of part of the system, device showing the mask, exit port and valve, with the person wearing the device exhaling a breath

FIG. 5 Is a side view of part of the system, showing the mask, exit port and valve, with the person wearing the device inhaling a breath

FIG. 6 is a front view of the exit port, without the exit valve shown

FIG. 7 is a front view of the exit port, with the exit valve shown

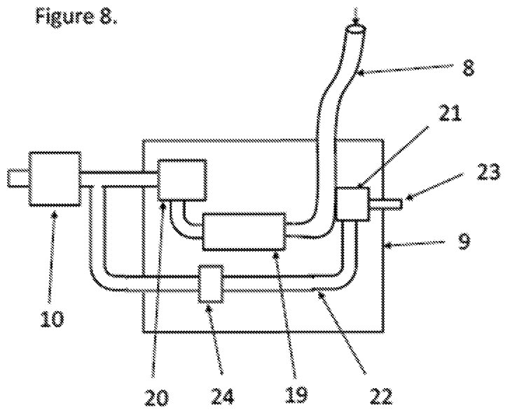

FIG. 8 is a cut through section of the processing unit, showing one possible arrangement of sub-units to remove or kill pathogens

FIG. 9 depicts an embodiment of a sneeze, cough and exhalation valve (SCEV)

FIG. 10 shows the skeleton flap of the SCEV

FIG. 11 shows the assembly of the SCEV and mask together

FIG. 12 shows an embodiment of the outflow chamber

FIG. A1: Pressure resistance at varying air flow rates, from Stenzler et al.

FIG. A2: Pressure under mask on cough.

### FIGURE KEY

(1) Mask
(2) Exit Port
(3) Low resistance one way valve
(4) Outflow chamber/variable compliance outflow chamber
(5) Inlet port
(6) Gas inlet port
(7) Connection
(8) Connecting pipe
(9) Processing Unit
(10) Suction Pump
(11) Exhaust pipe
(12) Mouth Mask
(13) Peak over Exit Port
(14) Flange around Exit Port
(15) Outflow chamber joint at the Exit Port
(16) Mask retaining strap
(17) Pressure sensor
(18) Signal cable to Vacuum Pump
(19) Electrostatic deposition sub-unit
(20) Filter sub-unit
(21) Pressure adjustment sensor and valve
(22) Over-pressure line
(23) Inlet pipe
(24) Over-pressure line filter
(25) Skeleton flap
(26) Low pressure exhalation valve
(27) Flap closure bar
(28) fixed closure edge
(29) closure spring
(30) stabilising bar
(31) cantilevered flap for exhalation valve
(33) proximal end nearest the face of the mask wearer

### DETAILED DESCRIPTION

The invention is a system comprising of a face mask and air handling system that captures the expired breath, from tidal breathing or from a cough or sneeze event, including gas, particles and aerosol from a human subject, and removes pathogens such as viruses and bacteria, so reducing the spread of pathogens to the surroundings and other people. The face mask captures air, aerosol and material from the nose and mouth of the wearer, or in one embodiment just the mouth. The system has a low resistance outflow from the mask such that the expelled material passes into an output chamber without a significant rise in pressure under the face mask that would most probably cause backflow of gas and expelled materials between the subject's face and the mask. The low resistance outflow is formed by having an exit port in the mask approximately in front of the wearer's mouth, with the exit port being of a large enough diameter so that the resistance to flow through the port is low. Within the exit port there is a low resistance exit valve that opens with little increase in pressure when the subject breathes or coughs or sneezes. This exit valve closes when the subject inhales, so that the subject does not re-breathe in the materials contained in their last breath or cough or sneeze. An inlet valve in the mask opens when the patient inhales, opened by the difference in pressure between the interior of the mask when the patient is inhaling and the atmospheric air pressure outside the mask. An additional piped gas inlet port is provided for the attachment of an air or oxygen delivery tube, with a blanking cap when not in use. The expired air having passed through the exit valve enters an outflow chamber which is of a relatively large volume compared to the cough or sneeze or single breath volume, and which has a wall material that presents little resistance to change in volume, and thereby there is little excess pressure resisting the flow of breath or cough or sneeze into the outflow chamber.

The air in the outflow chamber may then be filtered before passing into the environmental air, or a suction pump at the distal end of the system may draw the contents of the outflow chamber through a connecting tube and into a processing chamber, in which the pathogens in the airflow are killed, for example by UV irradiation or other toxic agents, or filtered or the droplets and aerosol are electrostatically deposited. The air flow, cleared of live pathogens, is then exhausted to the room, or may be vented to the outside of a building to obtain the benefits of dilution if, for example, there is any uncertainty about the efficiency or killing or deposition. Such uncertainty may arise if a new pathogen emerges and the system is being used to reduce spread before the sensitivity of the pathogen to toxic substances has been determined. The option to exhaust the expired air and materials to the open-air outside environment without the process of pathogen removal, that is without the flow being filtered, killed or deposited in the processing unit, may also be taken if a risk assessment shows that the risks are acceptable given the dilution in the open environment, for the actual or suspected disease that the subject is infected with.

The efficiency of removal of pathogens will not achieve 100%, due to the imperfections of the mask-to-face seal even at low pressure, and due to the imperfections of pathogen killing and filtering methods, but the airborne pathogen load will be reduced compared to the reduction achieved with a standard face mask, and therefore the risk to healthcare workers and others will be reduced.

### Mask and System

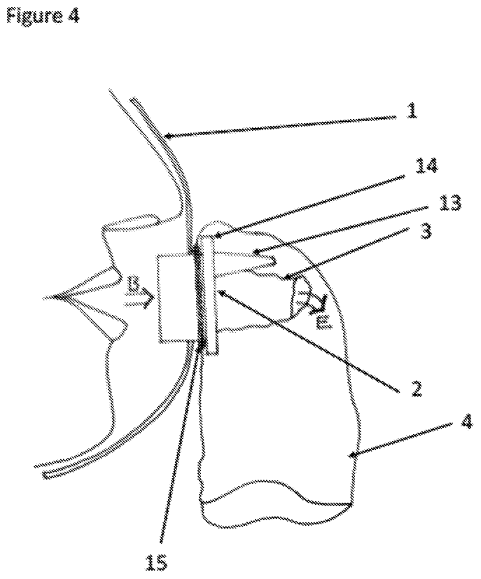

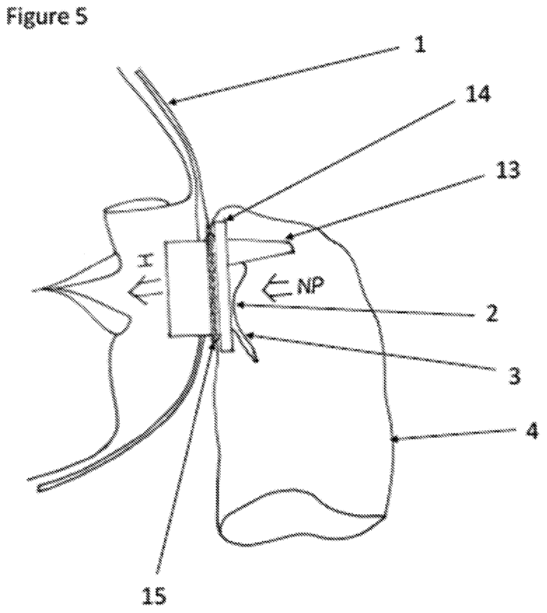

In one embodiment of the invention the capture of the expelled matter (where expelled matter is defined here as gases, droplets, particles and aerosol from a subject's mouth and nose) is enabled by having a mask and a system which has a low resistance to flow of the expelled matter from the space between the wearer's face and the mask. This low resistance is maintained even at a high rate of delivery (volume per second) of expelled matter such as occurs during cough or sneeze. In this description the person wearing the mask is referred to as “the wearer”. The face mask 1 is in general construction of the type commonly used to deliver oxygen or to filter the inspiration or expiration of airborne matter in medical or industrial settings, and in this embodiment the mask is of a soft material and with head straps 16 to keep it pulled close to the face. In the front of the mask there is an exit port 2 roughly at the level of the wearer's mouth, with a circular diameter of the order of the size of the opening of an adult mouth during breathing, cough or sneezing (in this embodiment 40 mm). The exact dimensions of a particular embodiment need to be matched to the population being served, and possibly different size fittings will be used to match more closely the mask and exit port to the individual, and also considering adult or child dimensions. The expelled matter passes through a low resistance one-way valve 3, such that it opens at a pressure of around 5 mm of water, being a low pressure that will not result in a significant backflow of expelled matter through any mask-face gaps. Pressures are expressed as the height difference in a water manometer. In this embodiment the low resistance one-way valve 3 is formed by a thin flexible material, such as a thin vinyl tube open at both ends , and it blows open when the pressure on the face side exceeds that on the outflow chamber side, and then falls closed and blocks flow when the pressure is reversed. An illustration of this is given in FIGS. 4 and 5. In FIG. 4 B is the expelled breath “E” escaping into the outflow chamber 4. In FIG. 5 the inspired breath “I” causes a pressure drop and the contents of the chamber cannot pass in the direction shown by arrow “NP”.

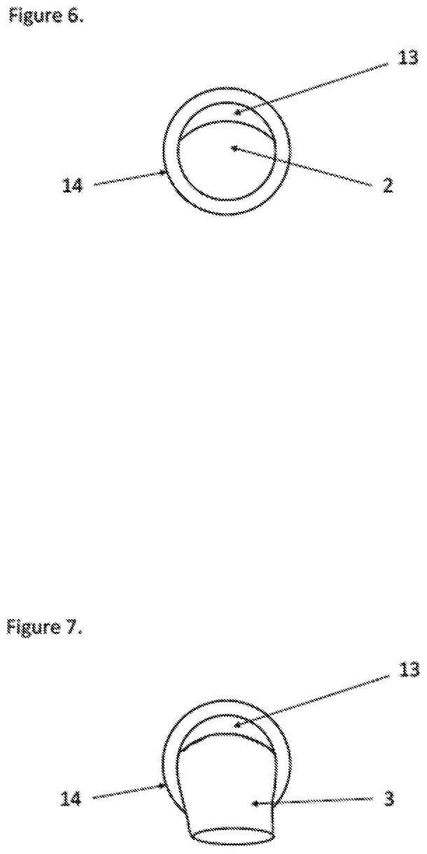

Further details of the exit port 2 and low pressure exit valve 3 for this embodiment are given in FIGS. 4, 5 and 6. In FIGS. 4 and 5 it is shown that in this embodiment there is a flange 14 which is used to attach the neck of the bag-like outflow chamber 4 by use of a circular clip or ‘O-ring’ (15, FIG. 4), or such a ring or clip formed in the neck of the outflow chamber bag. In this embodiment there is a projection 13 from the top of the exit port, much like the shape of a peak of a peaked cap, and this peak has the function of keeping the outflow chamber wall material from pressing on the material of the flexible valve which would restrict the flow of expelled matter into the outflow chamber.

The expelled matter then enters the outflow chamber 4, which is in this embodiment is formed by a very flexible thin walled plastic chamber such that its volume is at least that of two high volume adult coughs, where this is determined from the range of cough volume for the population being served. The essential feature of the outflow chamber is the pressure-volume relationship when a volume of air rapidly enters into it. The material is chosen so that it has little resistance to increase in internal volume, so that the pressure changes only minimally with increase in volume. The use of a thin plastic bag like material in this embodiment satisfies this requirement. If the wearer coughs, sneezes or expels a volume of air quickly then the outflow chamber fills rapidly, but because it is of sufficient volume to contain at least two high volume adult coughs, and the walls are thin and flexible and easily deformed under low pressure, then the pressure remains low on the wearer's face side of the exit port. The low pressure in the mask means that there is not a significant backflow of expelled matter between the face and the mask which would result in an uncontrolled release of pathogens into the air from an infected wearer.

The exit port valve closes when the pressure on the chamber side exceeds that on the face side, for example when the wearer inhales, and the inlet port on the mask side 5 opens to let air in, and there also may be air or oxygen inflow to the mask through the piped gas inlet port 6. The inlet port 5 has a one-way valve so that it is closed when the patient breathes out, or sneezes or coughs.

The expired matter in the outflow chamber must be removed, and this is either achieved by having a pathway for the OC fluid contents to pass through a filter and into the room air, or by arranging for a flow of the expelled matter through the connection 7 at the bottom of the outflow chamber 4, this can be achieved using a variable compliance outflow chamber described in more detail below. Optionally expired matter in the outflow chamber 4 can be removed by applying suction through the connecting tube 8 with the suction provided by the suction pump 10 pulling air through the processing unit 9. This flow reduces the gas volume in the outflow chamber so that it is ready to receive further flow through the exit port 2, and so that the back-pressure from the outflow chamber is kept low. The flow rate of expelled matter along the connecting pipe 8 may be set by a variable control of the suction pump 10 rate, adjusted by an operator to be the correct average flow for the patient. However, breathing, coughing and sneezing are variable, and so it is preferable that a sensor 17 in the outflow chamber, or another part of the outflow airway, detects pressure and provides feedback to the suction pump 10 via an electrical signal cable 18 to increase or decrease the suction and thereby vary the flow rate and the pressure in the outflow container.

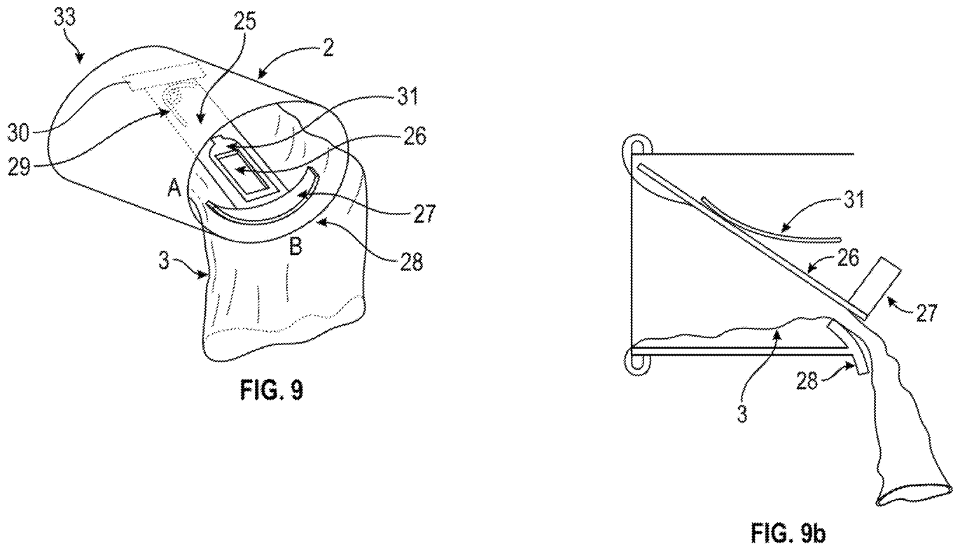

In order to ensure safety of the system in terms of not applying too negative a pressure in the outflow chamber, which may then open the valve 3 and result in a negative pressure at the patient's mouth and nose, it is preferable to have a sensor and valve triggered at low pressure by physical or electronic monitoring, to open and restore atmospheric pressure within the airway, and in this embodiment this sensor and valve is in the processing unit (21, FIG. 8). The valve opens to allow air into the system if the air pressure is too low, through the inlet pipe 23 or it opens to let expelled material out along the over-pressure line 22, passing through a filter 24 in the over-pressure line if the pressure is too high. An over-pressure alarm will sound until the pressure is reduced.

When the expelled material flows into the processing unit (9) it passes through sub-systems to remove pathogens by filtration or other means of physical extraction such as electrostatic deposition, and it may also pass through other sub-systems to kill pathogens before being exhausted to the room or environment through the pump (10) and the exhaust pipe (11).

The processing unit in this embodiment, by way of example, uses two of the methods of removing pathogens from the expired material shown in FIG. 8, passing the expelled material through an electrostatic deposition unit (19) and then through a filter, (20), before the cleaned gas travels on to the suction pump and is then exhausted into the local environment such, or the exhaust pipe is extended for the cleaned gas to be passed into the outdoor environment.

There are numerous other variations on the manner in which the invention may be embodied, and some of the possible variations are listed below:

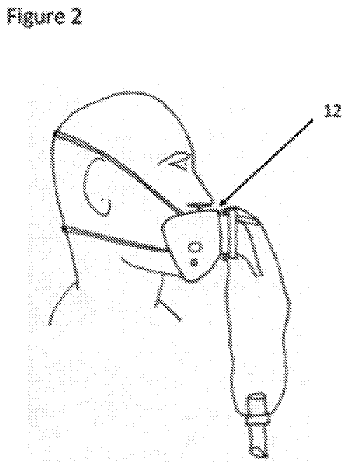

A mask covering the mouth only (FIG. 2) may be appropriate for certain diseases, for certain clinical conditions and certain patients in which there is little expelled material from the nose, and also when improved access to the nose is required, for example for delivery of oxygen therapy, though oxygen therapy can also be given through the full nose and mouth mask described above.

The face mask may be of a rigid material, instead of fabric. This may facilitate 3D printing of the mask, and also offers the potential that a 3D scanning device could scan an individual face and print a mask made to measure. An excellent fit is not required by this invention, since the back pressure is reduced, but a good face fit will increase the overall performance in containing pathogens.

The outflow chamber may be made of any material and construction that delivers the pressure-volume relationship described. For example a rigid material may be made into a concertina shape so that it expands and contracts with a pressure-volume relationship to provide the necessary pressure in the chamber to cause a flow of fluid out of the chamber when a suction is not applied. There are other variations possible to achieve the required performance.

The outflow chamber concept may be realised by having the tubing from the face mask of a relatively large diameter, say 50 mm or more, and this could then be extended to couple directly to the processing unit and thereby give a large volume, so that pressure changes on the inflow of a breath or sneeze volume are low due to the relatively low fractional increase in volume. This tubing can be constructed with walls of a material to provide the required pressure-volume relationship to provide expansion at low pressure and capacity to expand further on cough or sneeze fluid volume increase, such as a thin flexible plastic or in a rigid material with corrugations that expand and contract with little pressure.

The aim of removing pathogens from the interior environment could be achieved without the processing unit if the outflow from the outflow chamber is connected to the pump via a filter and is exhausted to the outside open air. This would require a risk assessment and an understanding of the likelihood that such outside air was not likely to re-enter any inhabited space, or flow where people are outside the building. Such a practice could be part of a protocol of how to deal with lack of spare filters or other supplies needed for the processing unit in times of shortage of supplies such as may occur in an epidemic or pandemic. In an ambulance transporting a patient, an outside roof vent may be used, given a risk assessment of the patient, the likely disease and the environment that the ambulance is travelling through.

The processing unit may serve several mask wearers, with a suitable arrangement of piping to deliver the expelled material from each mask wearer to the common processing unit. In this embodiment there would be one pump to produce the suction for a number of masks, for example to support mask use in a hospital ward or other location where several patients with the same disease are together, such as may occur in an epidemic or pandemic.

The system with the optional suction required can be made suitable for use for a wearer who is seated, in a domestic or hospital bed, and also for ambulatory subjects, or for patients undergoing transport inside a hospital, for example to go to a Radiology department for imaging, or in the community such as when ambulance staff are picking up a patient with a suspected highly infectious disease. This involves ensuring that tubing lengths are appropriate, and that system component are of a suitable size, such as having a small battery powered processing unit that can be attached to the wearer, or placed on a wheeled unit or attached to a wheelchair or stretcher.

The sizes of components in the system, particularly the face mask and outflow chamber, can be adapted to different adult sizes and lung capacities, and also for children.

The system that draws air through from the face outflow chamber to the exhaust can be triggered by pressure changes, or other sensors, for example a breathing monitor built into the face mask, to only apply suction through the system when the wearer breathes or coughs or sneezes, or when the pressure in the outflow chamber is outside of limits set in the controlling software running on an electronic computing device that is receiving sensor inputs.

### Sneeze, Cough and Exhalation Valve (SCEV)

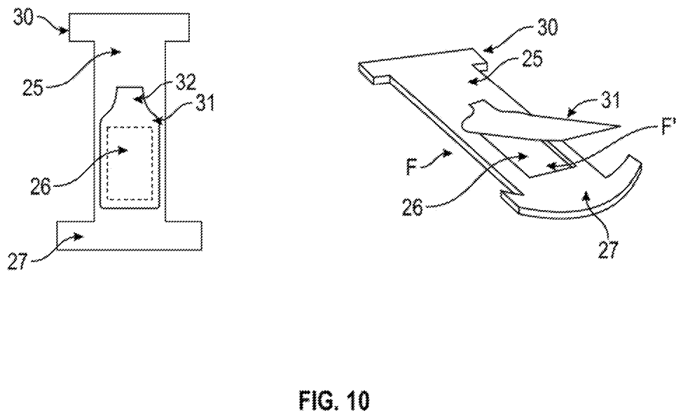

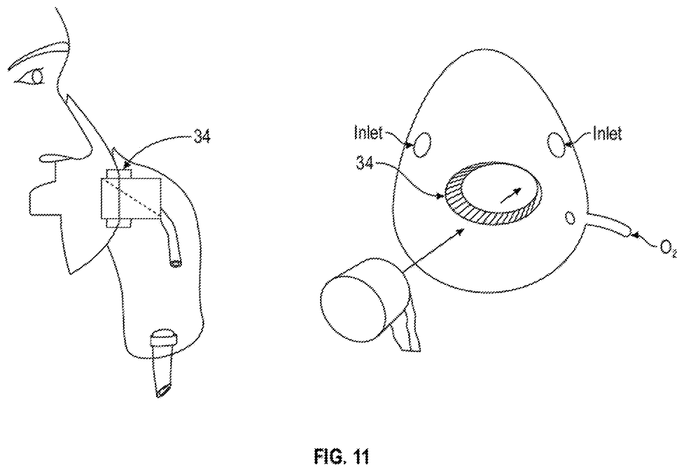

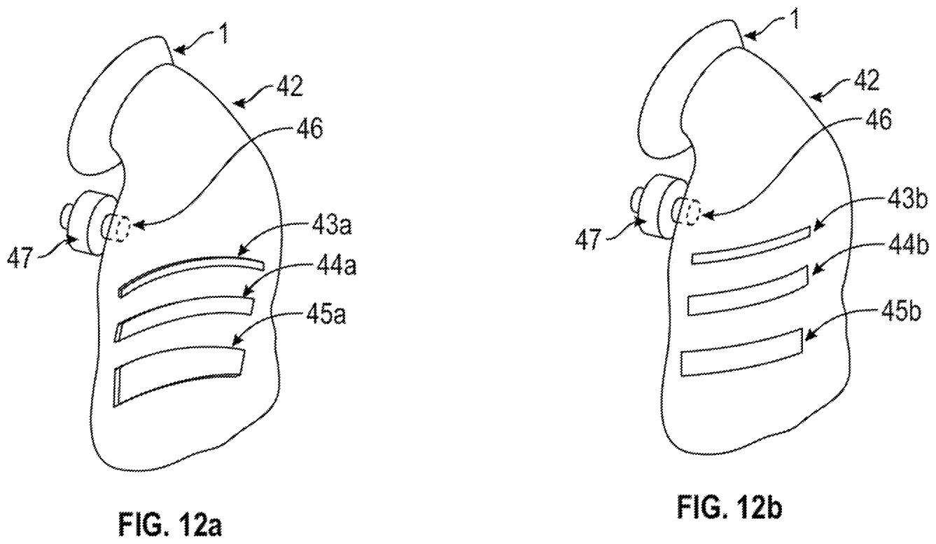

In a preferred embodiment the valve used takes the form of a sneeze, cough and exhalation valve (SCEV) as seen in FIGS. 9-11. The exit port tube 2 is a circular or elliptical or similar cross section tube which is lined by a soft material open at both ends, the soft valve and exit port liner 3. The exit port tube 2 slides into the fixed exit port guide 33 (see sketch 11). At the end of the exit port 33 nearest the mask wearer's face the soft liner 3 is attached in some manner to the tube rim to present the largest open aperture, and at the other end of the exit port the soft liner is partially attached to the exit port tube, by gluing or similar means, to the lower arc of the exit port tube, along the edge of the exit port tube along the arc between points A, B and C. The soft valve material is fixed in this way so that it can collapse under gravitational or other closing force applied with the minimum creasing when it folds down across the fixed closure edge 28, and it is for this reason that the exit port and the fixed closure edge 28 is of a curved profile so that the soft material will form the best seal possible against reverse flow of fluid back through the valve.

A skeleton flap 25 is attached to the upper surface of the exit port liner, and this has a flap closure bar 27 which is pressed against the fixed closure edge 28 under a combination of closing forces which may include gravity, tension in the soft valve material caused when the flap 25 opens and stretches the valve material to which it is fixed, an optional spring 29, or a magnetic closure arranged by fixing an appropriate magnet or magnets and possibly other magnetic material to the flap closure bar 27 and the fixed closure edge 28. The closure edge 28 may be shaped as in sketch 9b to improve the closure of the valve to improve the seal against flow of fluid into the mask.

The skeleton flap may have a stabilising bar 30 at the proximal end which tends to keep the skeleton flap from twisting around its long axis since the bar presses against the inside surface of the top of the exit port tube due to tension in the soft liner material that it is attached to.

An optional low pressure opening breathing valve 26 may be formed by an aperture through the skeleton flap 25 which is covered by a cantilevered flap 31, with the cantilevered flap 31 rising to allow fluid flow on a positive pressure inside the mask compared to the pressure in the outflow chamber.

The dimensions of the exit port tube are chosen so that the angle from the top of the entrance of the exit tube 33 to the fixed closure edge is around 50 to 60 degrees so that the gravitational force tends to exert a closing force on the valve until the exit port tube is tilted downwards by 50 to 60 degrees, and in this realisation this means an exit port length of around 40 mm and a height or around 35 mm.

The invention has the additional benefit that the exit tube can be simply inserted and removed, and the liner ensures hygiene compared to traditional valve flap mechanisms which may tend to become clogged in the humid environment of exhaled breath, and when splattered with droplets and mucous during cough or sneeze. The exit port tube has the potential to be a disposable element which is changed over the course of a day, and the face mask to be used for a longer period of time, reducing cost and waste. The mask body is then potentially for a single patient use and may for example washed at intervals, and the exit tube and valve assembly to be single use and then for disposal.

The SCEV valve assembly consists of the exit port tube and the soft valve installed as in sketch 9.

The valve assembly is seated in the mask by pushing it into the fixed exit port 33, where it forms a fluid tight seal. The mask wearer, referred to here as “the wearer” puts on the mask which is held in place by straps as in other masks.

On inhalation the pressure in the mask drops and the negative pressure pushes against the soft material of the SCEV and presses the flap closure bar 27 against the fixed closure edge 28, causing a high resistance to fluid flow back into the mask. The inlet valve or valves in the mask body open and allows air into the mask which the wearer inhales. When the inhalation phase ends the pressure under the mask is at atmospheric pressure as the inlet valves are open. When the wearer starts to exhale a normal breath the pressure in the mask rises and there is an opening pressure on the soft valve. The low pressure exhalation valve is optional, and if it is not present then the soft valve will open when the pressure exceeds the sum of the closing pressures due to gravity, any tension in the soft valve material attached to the skeleton flap, any optional spring force or optional magnetic closing force. The optional closing mechanisms may be desirable to cause a positive closure of the valve at the end of exhalation since if the wearer's head is tilted very far forward (more than 50 to 60 degrees) then the gravitational force on the valve will be zero or tend to open the valve in the resting state. Such a positive closing force may be arranged by having the skeleton flap attached to the soft valve material in a manner that when the valve opens the material is stretched, and this provides a closing tension. In realisations of the device in which there are positive closing forces employed in addition to gravity, this will provide a resistance to the outflow of fluid on exhalation, and such flows in the resting human can be at very low rate and very low pressure. Such quiet breathing represents low risk of aerosol generation, and so it is not required to capture all of this breath, but it may be clinically undesirable that the end expiratory pressure may need to rise so that the wearer can expel the air through leaks between face mask and the skin, and this becomes unacceptable if there is a very good fit between the mask and face since then the wearer may re-breath the oxygen depleted air that they have just breathed out. In these embodiments an optional low pressure opening exhalation valve 26 may be employed, allowing flow of exhaled fluid at low rates and low pressures. The optimisation of a given valve embodiment will keep to the requirements of having a low pressure opening of the cough valve, at under 10 mmH2O, and the closing forces will be arranged to achieve this by having any spring, magnetic or soft valve material to allow opening at pressures below 10 mmH2O.

At the end of exhalation the fluid flow leaving the valve will stop and there will be no pressure difference across the valve. If the soft valve has been open during exhalation then gravity and any other closing forces will be in play to close the valve. If only the low pressure exhalation valve has been open then this will close under the restoring force in the cantilevered flap flexible material, and gravity.

In the situation of cough or sneeze, the rate of fluid flow is very rapid, even explosive, and the rapid rise in pressure opens the soft valve to let fluid pass. If there is a low pressure exhalation valve present than this will also tend to open, and this is of no consequence as if it opens then it will be closed when the flap presses against the top of the exit port tube. When the cough/sneeze pressure and flow subsides the valve will feel the closing force due to the attachment of the skeleton valve to the soft valve material, and so will tend to close, and gravity and any optional spring mechanism will also come into play.

### Variable Compliance Self-Emptying Outflow Chamber

In one embodiment of the device discussed above the outflow chamber has a suction applied to cause flow of fluid out of the chamber, so that there is always sufficient volume capacity in the chamber such that if the person coughs or sneezes the chamber will increase in volume to contain the expelled fluids without increase in pressure.

The need for applied suction adds complexity and cost to the system, as well as introducing the need to ensure that the pressure in the outflow chamber does not fall to a negative value so that the mask exit valve opens and air is drawn from the mask before the wearer exhales. Such issues can be managed, but they require additional design features and so add complexity and cost.

Furthermore, in a system that needs externally applied suction there must to methods or features to ensure that the device is safe if the external suction fails, since potentially a failure to clear the outflow chamber results in the chamber becoming full and therefore further coughs or even breaths will meet an increasing resistance, and the fast rate of air flow in cough or sneeze may cause the backflow of coughed fluid, and the escape of pathogens, or even the rupture of the chamber under the rapid pressure rise.

For the above reasons an outflow chamber that functions without an externally applied suction is of significant value, and makes a safer device, and also less complex and costly. In addition it widens the areas that the device can be used in, for example in situations such as transport where power for suction may not be available, such as in moving a patient from their home to hospital, or moving a patient within the hospital for example between a respiratory care ward to the radiology department.

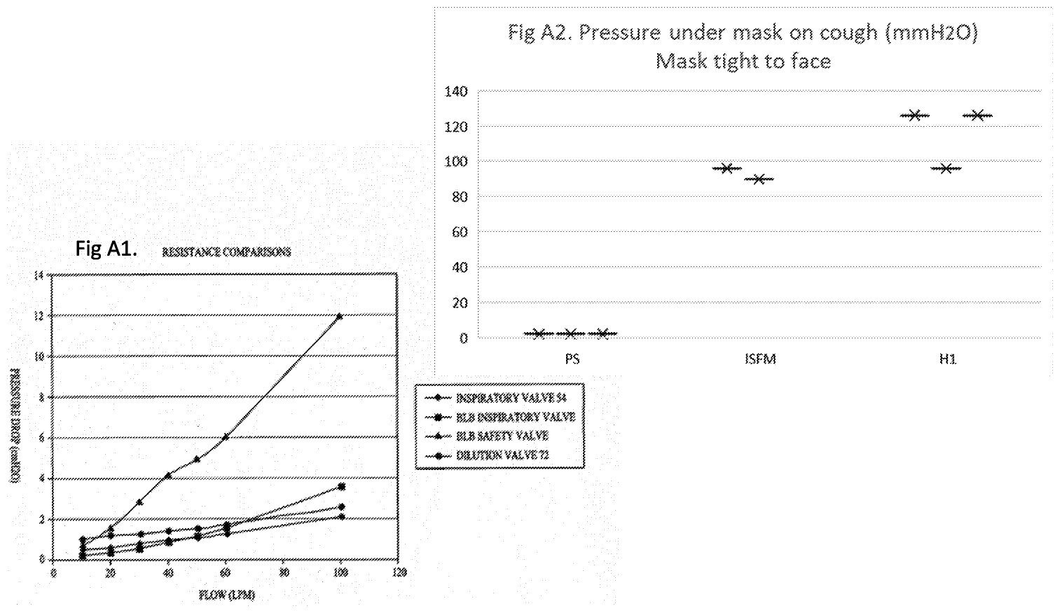

A preferred embodiment of the outflow chamber 4 is shown in FIG. 12. The Mask 1 is attached to the Outflow Chamber (OC) 42, in this embodiment formed by a bag of a material with low resistance to change in volume such as a thin walled plastic bag. Fluid comprising air, droplets and aerosol is expelled into the OC through a one way exit valve, and so the volume in the OC increases. The OC is constructed so that the volume will increase from it's minimum to a first volume V1 with a very low increase in pressure, say P1, then to increase the volume to V2 requires a pressure P2, and to increase the volume further to V3 requires a pressure P3, and so on. This provides a chamber with variable compliance, where compliance describes the relationship between volume and pressure. This may be realised in several ways, and the example in FIG. 12 shows strips of material 43a, 44a, 45a in FIG. 12a, which are attached to the OC wall and which have a pre-formed concave shape. The strips have a flexibility, and will deform under increasing pressure in the direction shown as D in FIG. 12b. Increasing pressure therefore increases the volume of the outflow chamber. The strips may have a different stiffness, so they deform under different pressures, and they may have different curvatures so that the volume changes at a different rate for the deformation of each strip. In the figure the strips are shown on the front surface of the OC, but they may be on any to all of the outflow chamber surfaces.

Under normal breathing, exhalation into the OC will result in around 0.5 L of air inflow, and the strip 43a may be of a stiffness so that it deforms under the 2 mmH2O to 5 mmH2O pressure increase. Note that pressures are measured as differences to atmospheric pressure in mm of water column height, mmH2O (1 Pa=0.1 mmH2O). The strip 43a then moves to the approximate position shown as 43b in FIG. 12b. When the exhalation stops the strip 43a has a restorative force and so the pressure in the OC is slightly above atmospheric pressure, and this pressure differential causes air to escape from the OC through the outflow port 46 and through the low resistance filter 47. The OC then reduces in volume by an amount before the next breath. If the next breath is a very high exhalation then the OC will expand and if strip 43a is maximally extended then the pressure will increase and strip 44a will distort in the direction D to position 44b and the volume will increase. At the end of exhalation the restorative tension in the strips will again expel air through outlet 46. The strips are chosen such that the OC can contain the expected volume of adult breaths, whilst maintaining an OC pressure under 10 mmH2O.

When the wearer coughs or sneezes there is a very rapid flow of fluid into the chamber, typically 4 L in 0.1 s for an adult male, and the strips 43a, 44a, 45a can deform under the rapid rise in pressure to provide compliance such that the pressure does not rise sufficiently to cause backflow of fluid in the mask (blow back of the expelled fluid past the mask), and the compliance of the OC ensures that the pressure rise is low, typically no more than 10 mmH2O. After the cough the restorative tension in the strips will cause the pressure in the OC to be maintained and will cause fluid to be expelled through port 46 and through filter 47.

An optional connection may be put onto the filter so that an external suction may be applied if it is required to remove the fluids for filtration or pathogen killing in a processing unit. Alternatively an optional adaption to the filter unit may be made so that a suction may be applied and the fluid passing through the filter can flow through another filter or exhausted to the environment

Other means of achieving the variable compliance may be through having an Outflow Chamber with walls of variable stiffness, with a thin walled section to provide very low resistance and then gradually thickening or otherwise changing resistance so that the volume versus pressure curve gives the characteristics desired and described above. Other construction profiles, such as concertina section walls may also be constructed to produce the desired behaviour.

The invention has been described with reference to a preferred embodiment. The description is intended to enable a skilled person to make the invention, not to limit the scope of the invention. The scope of the invention is determined by the claims.

1. A face mask system for removal of pathogens from exhaled air comprising at least one flexible layer comprising a first surface and a second surface, said second surface being opposite to the first surface, and the first surface being in sealingly contact with the face of a user and the second surface being exposed to the environment, wherein at least one layer is provided with an exit port and an inlet port and further wherein the exit port is sealingly connected to a deformable outflow chamber and said exit port further comprising a one way exit valve that is configured to open when a user exhales air and which exit valve closes when the user inhales air.

2. The facemask system of claim 1, wherein the exit port is of a diameter that is dimensioned not to impede the flow of exhaled air into the deformable chamber by means of the one-way exit valve.

3. The face mask system of claim 1, wherein the inlet port comprises an inlet valve that is configured to open when a user inhales air and which inlet valve closes when the user exhales air and further wherein the inlet valve is configured to open by the difference in pressure between the first surface of the at least one layer and atmospheric pressure of the environment.

4. The face mask system of claim 2, wherein the deformable outflow chamber is sealingly connected to a processing unit by means of a flexible conduit, said conduit configured to transport expelled matter from the user via the exit port of the at least one layer and the deformable outflow chamber.

5. The face mask system of claim 4, wherein the processing unit is connected to a suction means comprising an exhaust outlet and said suction means configured to provide suction through the conduit via the processing unit and the deformable outflow chamber to define from the exit port a path of exhaled air, said suction means optionally comprising an electrostatic deposition unit and a filter to provide a clean gas output at the exhaust outlet of the suction means, and further wherein the processing unit comprises a valve, and a sensor.

6. The face mask system of claim 1, wherein the deformable outflow chamber is sealingly connected to a suction means by means of a conduit, said conduit configured to transport expelled matter from the user via the exit port of the at least one layer and the deformable outflow chamber.

7. The face mask system of claim 5, wherein the flow rate in the path of exhaled air may be set or variably controlled by the suction means and optionally in a feedback arrangement with a sensor in the path of exhaled air.

8. The face mask system of claim 6, wherein the valve is configured to open to allow air into the system through the inlet pipe or it opens to let expelled material through an over-pressure line via a filter.

9. The face mask system of claim 1, wherein the outflow is low resistance such that expelled air passes into the output chamber without a significant rise in pressure between the user and the first surface of the at least one layer.

10. An outflow chamber suitable for use with the face mask system of claims 1 comprising:
a lightweight deformable chamber having a one way inlet for sealed connection to an outlet of a face mask, and a one way outlet valve distal the inlet, the chamber increasing in volume as internal pressure rises and decreases as internal pressure drops.

11. An outflow chamber according to claim 10 further comprising at least one support strip attached to a surface of the outflow chamber, the at least one support strip being deformable between a biased first preferred concave shape and a second convex shape relative to the outflow chamber, such that as the internal pressure of the outflow chamber increases in relation to ambient pressure, the support strip transitions from the concave position to the convex position and urges the outflow chamber to a larger internal volume, as the internal pressure decreases the support strip returns to its preferred concave position.

12. An outflow chamber according to claim 11 comprising a plurality of support strips.

13. an outflow chamber according to claim 12 wherein each of the plurality of support strips transition from the first position to the second position at different internal pressures of the outflow chamber.
